(19) United States
(12) Patent Application Publication
(10) Pub. No.: US 2022/0156224 A1
(43) Pub. Date: May 19, 2022

(54) APPARATUS FOR THE SPECTROSCOPIC DETERMINATION OF THE BINDING KINETICS OF AN ANALYTE

(71) Applicant: Surflay Nanotec GmbH, Berlin (DE)

(72) Inventors: Goetz Daehne, Berlin (DE); Lars Daehne, Hoppegarten (DE); Michael Himmelhaus, Berlin (DE)

(21) Appl. No.: 17/438,446

(22) PCT Filed: Mar. 11, 2020
(86) PCT No.: PCT/DE2020/100177

§ 371 Date: Sep. 12, 2021

(30) Foreign Application Priority Data
Mar. 12, 2019 (DE) 10 2019 106 194.6

(51) Int. Cl. G06F 15/78; G01N 21/64; G01N 21/77

(52) U.S. Cl. CPC G06F 15/7892; G01N 21/645; G01N 2021/6421; G01N 2021/6439; G01N 21/7746

(57) ABSTRACT

The invention relates to a device for the label-free quantitative spectroscopic determination of the binding kinetics of an analyte. Essential components of the device, namely a light source (2), optical elements (5; 6; 7; 8; 9; 13; 13′) for beam guidance and for optically influencing the light of the light source (2) and light modes emitted by a microsensor (functionalized spherical microparticle) retained in a microstructure (3) as a result of the exposure to the light of the light source (2), a spectrometer, which consists of an optical receiver (10) for the emitted light modes and an evaluation unit, actuators (14; 15) for positioning a carrier (4) with the microstructure (3) arranged thereon, and at least one control unit, are jointly arranged in an apparatus (1) having an apparatus housing (11). The light, namely the light of the light source (2) and the light modes emitted by a microparticle in question as a result of the exposure to said light, is guided in three different planes within the apparatus housing (11) by means of the optical elements (5; 6; 7; 8; 9; 13; 13), in particular by means of a first optical deflecting element (6) and by means of a second optical deflecting element (7).

The invention relates to an apparatus for the quantitative determination of the binding kinetics of an analyte. By means of the apparatus, in particular, where possible, the rate at which the respective analyte binds to a complementary unit can be determined for different analytes that are each contained in a fluid. The determination of this rate, that is, the adsorption rate, takes place by means of the apparatus in a spectroscopic way and in a label-free manner, that is, without a special labeling of the analyte itself being required. Beyond this, by means of the apparatus, it is possible—conversely, as it were—to determine a desorption rate and, in the process, likewise in a label-free manner, also the rate at which an analyte bonding to a complementary unit is released, that is, is desorbed from this complementary unit by a moving fluid. The determination of desorption rates takes place, for example, within the framework of release studies or in assessing the stability of coatings that are to be applied onto a surface.

Insofar as, in the following description and in the patent claims, reference is made to the determination of binding kinetics, this means, in the broadest sense, the determination of data that describe these binding kinetics, that is, in particular, the time course of the binding of an analyte to a complementary unit or else its release from a complementary unit, that is, the determination of an adsorption rate or of a desorption rate, and/or derivable from these, physical quantities or chemical properties relating to the analyte. In regard to the preferred intended use of the apparatus, the following descriptions relate in general to the determination of adsorption rates, but without any limitation of the invention thereto. The term “binding kinetics” and the formulation “determination of the binding kinetics” thus include both possibilities of using the apparatus, that is, its use as desired either for observing adsorption processes or for observing desorption processes. Likewise, separately from the exemplary embodiment, which, in any case, does not have any limiting effect, statements made in regard to the adsorption rate, that is, in regard to the determination thereof, always refer as well, in an adequate manner, to the desorption rate, that is, to the determination thereof. The invention itself relates, in particular, to key components of the apparatus arranged together in an instrument, the design thereof, and their interaction.

For different purposes, it is necessary to determine the binding kinetics, namely, in particular, the adsorption rate at which a particular analyte that is being observed binds to a complementary unit or the rate (desorption rate) at which such an analyte is released from a surface. The analyte can be, for example, a chemical substance, such as a medicinal active ingredient, a DNA segment, or an antibody, or else it can be a heavy metal or a nanoparticle. Thus, for example, in pharmacology in the development of pharmaceuticals, it is important to know how an active ingredient contained in a medication binds in the body, namely, in particular, to specific cells in the body. The determination of the adsorption rate that takes place in the laboratory in this case takes place starting from a liquid that carries the analyte in question or, more generally, starting from a fluid that carries the analyte.

Whereas, in accordance with methods established for this purpose, the determination of corresponding adsorption rates often takes place by way of a suitable labeling (for example, radioactive labeling) of the analyte that is being observed here, methods that do not require a labeling of the analyte, that is, label-free methods, have increasingly been employed for some time. Used for this purpose, for example, are surface sensors, which are furnished with a substance that is complementary to the analyte in question, that is, a substance suitable for binding the analyte to the surface. The surface that has been functionalized in this way is then exposed to an incident flow of a fluid containing the analyte and is investigated as to the way in which and the time course in which physical properties of the surface are changed by the analyte binding to it. Through analysis of the change in these physical properties of the surface, such as, for example, the change of a surface charge or of the dielectric behavior, as observed over time, it is then possible, by way of comparison, to draw conclusions about the adsorption rate. Examples of comparative methods or of apparatuses making use thereof are SPR (SPR=surface plasmon resonance), quartz crystal microbalance, or reflectance interferometry.

Different forms of surface sensors of this kind are described, for example, in DE 10 2014 104 595 A1. The published specification in this case also addresses the weak points of the described surface sensors and the drawbacks associated with the use thereof. In order to avoid the drawbacks that are pointed out in this connection, the apparatus claimed in the specification uses a spectroscopic method that utilizes a special microstructure, which is also referred to as a fluidics chip.

Similar microstructures for comparable purposes are described, in addition, in US 2003/0186 426 A1, US 2017/007 4870 A1, WO 2010/141 365 A2, and WO 93/22053 A1.

The microstructure involves one microchannel or, preferably, a plurality of microchannels introduced into a suitable substrate, such as, for example, a substrate made of glass, with a height and a width of a few micrometers in each case. In the microchannels, a holding structure in the form of one depression or a plurality of depressions provided on the bottom of the microchannels is formed. In the preferably plural depressions, which, for example, are dome-shaped, microparticles are introduced by washing them, for example, into the microchannels with the help of a fluid, that is, for example, by means of a liquid, and allowing them to sediment out on the bottom of the rnicrochannel in the region of the depressions formed therein. The transparent spherical microparticles are functionalized on their surface for specific binding of the particular analyte that is to be investigated in terms of its adsorption rate, and, in their interior, they have a fluorescent dye that can be excited by light to glow. In this way, they create microsensors.

For the purpose of determining an adsorption rate or a desorption rate, a particular microparticle is exposed to the focused light of a light source, preferably of a laser. The fluorescent dye contained in the microparticle is thereby excited to emit light, the wavelength spectrum of which is governed by the composition of the dye and by the size of the particular microparticle. For light modes of specific wavelengths of this spectrum (whispering gallery modes=WGM), the microparticle in this case represents a resonant cavity that is comparable to the resonator of a laser, so that, through total reflectance at the inner side of its surface, these light modes in the interior of the microparticle form a standing wave and are thereby amplified before, finally, a portion of this light exits the microparticle.

For the light modes emitted by the microparticle, the peak wavelengths are determined by use of a spectrometer. Afterwards, the previously described microstructure is flushed by a fluid containing the analyte to be investigated. The analyte binds to the functionalized surface of the microparticle, that is, of a microparticle that has been investigated spectrographically beforehand in the absence of the analyte. If, during this binding process, the microparticle is now exposed repeatedly to light serving to excite the dye contained therein, the position of the previously determined peak wavelengths of the light modes emitted by the microparticle on account of its exposure to the light is changed owing to the change in the refractive index because of bindings to the outer surface of the microparticle. This change in the peak wavelengths, which is detected spectrometrically, that is, by means of an optical receiver, can be analyzed computationally and, from it, conclusions can be drawn about the adsorption rate of the respective analyte being observed.

The previously described excitation of the microparticles contained in the microstructure and the spectrometric detection of the light modes that are emitted from the microparticles on account of the optical excitation necessitates a relatively complex and precisely calibrated optical setup. In the corresponding laboratory, optical benches are usually employed for this purpose, along which the optical components required in each case are arranged, whereby the optical components that are provided for the further transmission, the optical processing, and the reception of the light modes emitted by a microparticle are usually arranged along an axis. On the one hand, this necessitates a certain amount of space. On the other hand, however, it is also necessary to resort to more complicated measures in order not to disturb the precise arrangement and optical calibration of the components and the beam guidance and light processing effected by means of these components and thus to impair the result of the investigation.

The object of the invention is to provide an apparatus for the label-free quantitative determination of binding kinetics, namely, in particular, for the determination of the adsorption rate of an analyte contained in a fluid or also the determination of the desorption rate of an analyte released into a fluid, which uses the principle of analysis and a microstructure of the above-described kind and in this case has a construction that is as compact as possible and is relatively robust.

The object is achieved by an apparatus having the features of patent claim 1. Advantageous implementations and further developments of the invention are presented by the dependent claims.

The apparatus according to the invention for the label-free spectroscopic determination of the adsorption rate of an analyte contained in a fluid or for the determination of the desorption rate of an analyte released into a fluid and the key components thereof will be presented below. The key component part of the apparatus, first of all, includes a light source for the emission of light used for the spectroscopic analysis. This light source is preferably a pulse-width-modulated laser with a power of between 0.1 mW and 10 mW.

An analyte that can be analyzed by means of the apparatus according to the invention in terms of its adsorption behavior or desorption behavior can be, as already mentioned at the beginning, for example, a chemical substance, such as a medicinal active ingredient, a DNA segment, or an antibody or the like, but also heavy metal ions or nanoparticles.

A further component part of the apparatus is a module, referred to here as a fluidics module, which is comprised of a movable carrier and of a microstructure that is arranged on this carrier and through which a fluid can flow. At least one microparticle, which functions as an optically active rnicrosensor is held by the aforementioned microstructure, which is of corresponding design. The terms microsensor and microparticle are therefore also used synonymously below. A fluid in the context of the presented invention is understood to mean a liquid or a gas (also air, depending on the case).

The at least one microsensor is designed for binding an analyte that is carried in a fluid to the microstructure or—in the case of the determination of a desorption rate—for the release of an analyte already binding to its surface into the fluid delivered to the microstructure. Furthermore, it is designed for the emission of light modes resulting from exposure to the light of the light source mentioned at the beginning and is therefore also referred to, in the context of this description for explanation of the invention, as an optically active microsensor. What is involved here is a spherically shaped microparticle, that is, a spherical microparticle of the kind described at the beginning in the discussion of prior art, with a diameter of between 5 μm and 30 μm, preferably between 7 μm and 12 μm. Depending on the design of the fluidics module, the microstructure thereof is designed for the purpose of holding one such microsensor or preferably a plurality of such microsensors. The microparticle or microparticles that is or are held by the microstructure and, in each instance, is or are exposed individually to the light of the light source by respective positioning of the carrier of the fluidics module absorbs or absorb the incident light and emits or emit the specific modes (WGM). The wavelengths of these specific modes are governed by the fluorescent dye of the respective microparticle and by the resonances that arise depending on the particle size as well as by the changing difference between the refractive index of the microparticle and that of its immediate surroundings resulting from the adsorption or desorption of the analyte.

The fluidics module can be preferably a fluidics chip having a microstructure of the kind likewise described in connection with the discussion in regard to the prior art. The microstructure in this case has one microchannel or a plurality of microchannels through which a fluid can flow, with one depression or a plurality of depressions having a depth of between 5 μm and 30 μm being provided on the bottom of each channel so as to create a holding structure for one spherical microparticle in each instance. The microparticles held in this microstructure in each instance depending on the intended use of the apparatus are—as already described—spherically shaped (spherical) microparticles, the surface of which is functionalized in a complementary manner for the purpose of specifically binding a particular analyte being investigated in terms of its adsorption behavior and which, beyond this, has a fluorescent dye in its interior, which, on exposure to light of a specific wavelength, emits the light modes that are taken for spectroscopic analysis. Obviously, the fluidics module is furnished with corresponding ports, via which the respective fluid is carried to the microchannel or microchannels.

Apart from the embodiment described once again above, however, the fluidics module can also be realized in the form of an array of living cells, of a chip (dielectrophoresis chip) controlled by means of electrical fields, or of an optically controlled chip (laser tweezers) or can have at least one sensor that is trapped in microfluidic droplets. However, the fluidics module itself is not intended to be the subject of detailed considerations within the scope of the invention presented here, because, for example, it is already fundamentally known in the embodiment described in detail previously and hence it is not itself the subject of the invention,

Nonetheless, at this point, a number of comments should be made in this regard. Insofar as it ensues from patent claim 1 that a fluid is carried to the fluidics module and/or that the fluidics module is designed for carrying a fluid and/or that the apparatus comprises means for moving and for carrying a fluid to the fluidics module, this means that, in the individual case, it is also possible to carry a fluid that is different from the fluid containing the analyte or different from the fluid releasing the analyte from a microparticle to a fluidics module that is designed in the way described in detail previously. The fluidics module is an exchangeable component. This component can thus be brought into an operative connection, together with a microstructure holding one microsensor or a plurality of microsensors, with the other components of the apparatus, or also can be introduced as a module, in the microstructure of which one microparticle or a plurality of microparticles is or are introduced only after connection of the module to the components of the apparatus—for example, only immediately preceding the investigation of an analyte in terms of its adsorption behavior or desorption behavior.

In the last-named case, a fluid is carried to the fluidics module prior to the actual investigation process by use of the already mentioned means in patent claim 1 for the movement and carrying of fluid to the microstructure in which the optically reactive elements that are to be fixed in place on the holding structure for the binding or for the release of the analyte to be investigated, namely, the functionalized microparticles, are suspended. This means that the actual analysis operation is preceded by a flushing operation for introducing microparticles in the microstructure. Both possibilities, that is, both an apparatus for which microparticles are already fixed in place on the microstructure in the fluidics module belonging to the apparatus and also an apparatus for which the introduction of microparticles in the microstructure occurs only directly prior to the actual analysis operation, are accordingly to be comprised by the invention. Beyond this, a fluid that is carried to the fluidics module via said means can also serve for flushing the microstructure in order to release “spent” microparticles after the conclusion of an analysis operation.

Component parts of the apparatus according to the invention are, besides the light source for the emission of light used for the spectroscopic analysis, namely, the light used for excitation of the fluorescent dye contained in the microparticles, and besides the fluidics module, additionally elements for beam guidance of the light emitted by this light source and for beam guidance of light modes emitted by a microsensor held in the microstructure. Belonging to these optical elements is, in particular, an objective lens or objective, on which the light modes emitted by a sensor of the microstructure of the fluidics module impinge, that is, via which these light modes are incident in the instrument in their further transmission, further processing, and, finally, their being guided to an optical receiver that likewise belongs to the apparatus.

Besides the above-mentioned optical receiver, which is preferably a CCD or CMOS line scan camera, the apparatus further includes actuators for the positioning of the carrier of the fluidics module, means for the movement and carrying of a fluid to the fluidics module, an analysis unit for the determination of the adsorption rate of the respective analyte being observed in this regard by analysis of the light modes received by the optical receiver, and at least one control unit for control of the light source, for control of the actuators for the positioning of the carrier, and for control of the means for the movement and carrying of fluid. The last-mentioned units, namely, the analysis unit and the at least one control unit, can be designed, if need be, as a common unit. In the case of such a common unit, what is involved can be, for example, a microcontroller system.

In the apparatus according to the invention, at least the light source thereof, the optical elements for beam guidance, the optical receiver, and the actuators for the positioning of the respective microparticle that is held in the microstructure and is to be irradiated in the three spatial directions x, y, z by movement of the carrier of the fluidics module, are arranged together in one instrument and are consequently accommodated by a common instrument housing. By means of the actuators (xyz stage), it is thereby possible to very precisely position the carrier or, to be more exact, a respective microsensor that is held by the microstructure arranged on the carrier, namely, preferably with an accuracy of better than 0.2 μm.

In this case, in accordance with an especially preferred embodiment of the invention, the optics of the actual spectrometer, that is, preferably the already mentioned line scan camera, is additionally surrounded within this instrument housing by an additional housing in order not to impair the result of the highly sensitive measurement owing to the influences of extraneous light.

The feature according to which the aforementioned components are arranged together in an instrument is to be understood in this connection in the sense that a particular one of these components is either completely surrounded by the instrument housing of this instrument or else is encased relative to the outside, in a manner that is at least partially visible, at least by a housing wall of the instrument housing, whereby, if need be, the component projects through the housing wall in question partially or essentially completely. For example, as will also be shown in connection with the exemplary embodiment to be discussed below, the latter can apply to the already mentioned objective, which receives the incident light modes that are emitted by a microsensor of the microstructure.

The special challenge of installing the aforementioned components in the instrument housing of an instrument that accommodates them together consists in designing the instrument in question in such a way that, on the one hand, it has a compact construction, but, on the other hand, the light path, which, in each case, is laid out at least nearly completely within the instrument housing, is long enough for the light modes that are emitted by a microsensor held in the microstructure and that are to be guided to the optical receiver to be received at the receiver with a sufficiently high resolution, that is, with a resolution that makes possible a reliable determination of an adsorption rate (or desorption rate). For the apparatus according to the invention, this is ensured in that the light is guided within the instrument housing—and what is hereby meant is any light that is guided within the instrument housing, that is, both the light that is emitted by the light source and also the light of the light modes that is emitted by the particular microsensor of the microstructure—into three different planes.

This is conducted by deflecting light that is emitted by the light source and is guided initially in a first plane for the precise exposure of a microsensor (microparticle) held in the microstructure of the fluidics module by means of an optical deflection element into a second plane, and by deflecting the light modes that are guided initially in the opposite direction, likewise in this second plane and that are emitted by a particular microsensor in the microstructure as a result of the light exposure and are taken for the determination of the adsorption rate by means of a second optical deflection element into a third plane that is different from the first and second planes. The light modes that are emitted by the microsensor that is held in the microstructure and is irradiated with the light of the light source and that are to be analyzed are finally guided via further optical elements to the optical receiver. In the fluidics module used in the apparatus according to the invention, very high-grade sensors are used for the (as stated, preferably plurality of) microsensors held by the microstructure thereof and, in these sensors, the spectral full width at half maximum (FWHM) of the emitted modes is less than 200 pm.

In accordance with an especially preferred embodiment of the apparatus, the beam guidance of the light within the common, key components of the apparatus, such as, in particular, the instrument housing accommodating all optical components, is such that the light emitted by the light source is guided initially along a first coordinate axis in the space and is then deflected by means of a first beam splitter (first optical deflection element) in a wavelength-selective manner and is guided along a second coordinate axis in the space, which is orthogonal to the first coordinate axis, onto the microstructure. In this embodiment, the light modes that are emitted by a microsensor in the microstructure as a result of the light exposure are guided initially likewise along the aforementioned second coordinate axis, but in the opposite direction to the light guided onto the microstructure for the partial light exposure, and then, by means of a second beam splitter (second optical deflection element), are deflected in a wavelength-selective manner and guided along a third coordinate axis, which is orthogonal both to the first coordinate axis and also to the second coordinate axis in the space, via an optical slit aperture to an optical grating. Finally, the light that is reflected by the grating and is fanned out according to wavelength is then guided to the optical receiver.

In an especially preferred embodiment of the apparatus according to the invention, the fluidics module is arranged outside of the instrument housing at a housing wall of the key components of this apparatus that have been mentioned in the basic description of the invention, such as, in particular, the instrument housing accommodating the optical elements. To this end, the fluidics module, namely, the microstructure-supporting carrier for it, has suitable mechanical coupling means, that is, as it were, a mechanical interface, via which the fluidics module is joined to corresponding complementary mechanical components (adapters), which are accessible at the instrument from the outside and via which the mechanical interface can be brought into an operative connection with the actuators for the positioning of the microstructure arranged on the carrier.

This embodiment has the advantage that, depending on the analyte that is to be analyzed in each case, the fluidics module can be exchanged in a simple manner, that is, can be refitted and, namely, this can be done without the need for any intrusion in the instrument. This, in turn, has the advantage that, on the one hand, it is not necessary to provide at the instrument housing any corresponding access possibilities (flaps, windows, or the like) and a person who is operating the instrument does not potentially come into unintended contact with the high-precision optical components or with the elements thereof that are provided for adjustment and calibration thereof, preferably at the factory, when the fluidics module is exchanged or removed after the conclusion of an analysis.

In the previously described embodiment, the already mentioned objective lens for incidence of the light of the light modes emitted by a microsensor, this objective lens being encased in an opening provided for it in the housing wall, is arranged directly adjacent to the fluidics module that is mounted at this housing wall via the already mentioned adapters. The objective is preferably not an immersion lens, but rather a dry objective lens with a 5× to 100× magnification, preferably a long-distance dry objective lens with a 10× to 40× magnification, especially preferred with a 20× magnification, and with a numerical aperture of between 0.6 and 1.2, but preferably of at least 0.75 (NA≥0.75).

In regard to the previously mentioned objective lens that projects through the housing wall, the instrument of the apparatus according to the invention can be designed in such a way that the objective lens can be exchanged. Depending on the particular concrete individual case, the instrument can accordingly be operated with different objective lenses in the analysis, This can also be ensured, moreover, by equipping the apparatus with several different objective lenses, of which, in each instance, one objective lens, namely, the objective lens required for the specific analysis operation, is moved into an operative position—for example, by means of a correspondingly controlled revolver construction—in which the light modes that are emitted by a particle of the microstructure can be guided via this selected objective lens in the instrument housing. The invention is also intended to comprise explicitly an embodiment of this kind.

As already discussed, as a light source in the apparatus according to the invention, preferably a pulse-modulated laser with a power of between 0.1 mW and 10 mW is used, with a pulse-modulated laser with a power of between 0.5 mW and 1.5 mW being especially preferred. It applies here that the laser power is to be of such a magnitude that, on the one hand, the microsensor that is taken in each case for the determination of the adsorption kinetics and is irradiated by the laser spot is reliably excited for the emission of analyzable light modes, but, on the other hand, a premature fading of the microsensors, that is, of the fluorescent dye of the microparticle, owing to too strong a heating as a result of the irradiation with the laser light, is avoided. The latter is also the reason for the fact that a particular microsensor is irradiated by the light source in each instance only for the duration of the measurement operation and that the laser is triggered in a pulse-width-modulated manner and the entire receiver-side analysis of the incident light modes is accordingly triggered in a corresponding manner therewith. For the apparatus according to the invention, the laser power, the duration of the measurement, and the frequency of the measurement can be adjusted at will, depending on the applied case and taking into account the nature of the microparticle used here in each instance, that is, taking into account quantities such as the rate of adsorption, the rate of fading of the microparticle, and the signal intensity determined on the receiver side.

In an advantageous further embodiment of the invention, the apparatus comprises a camera that is likewise integrated in the instrument. In the case when the mentioned wavelength-selective beam splitter is used to effect the light guidance that is provided in accordance with the invention within the instrument housing, the pertinent embodiment is designed in such a way that those light waves that, for the purpose of the analysis, are not guided to the grating and subsequently to the optical receiver and that pass through the second beam splitter without any deflection are guided to the aforementioned camera. The camera is connected via corresponding connection terminals at the instrument housing to an imaging system, such as a monitor, via which an optical monitoring of the automatic positioning of the particular microsensor that is to be irradiated can take place by corresponding movement of the carrier of the microstructure during a respective analysis operation and the analysis operation can take place in terms of scanning the microparticles held in the microstructure. The automatic scanning of a single particular microparticle from a plurality of microparticles held in the microstructure, that is, in accordance with a practice-relevant design of the fluidics module, is ensured by the identification thereof by the use of software in the framework of an image processing.

For the last-mentioned purpose, it is possible in a further embodiment of the invention to arrange yet an additional lighting device—preferably a diffuse light source—at the instrument housing, by means of which the fluidics module can be irradiated without any influencing of the light used for the analysis and without any influencing of the light modes that are emitted by a microsensor and are taken for the analysis.

A further advantageous embodiment of the apparatus according to the invention consists in the fact that the analysis unit, which was mentioned at the beginning, for the analysis of the light modes incident at the receiver, and the at least one control unit, that is, for example, a microcontroller unit realizing the last-mentioned component, are arranged in the common instrument housing that also accommodates the optical components.

In regard to the apparatus according to the invention, or, to be more exact, in regard to the instrument accommodating the key components that essentially represent this apparatus, such as the optical elements, an exemplary embodiment will be presented and discussed below on the basis of drawings.

Shown in the appended drawings are:

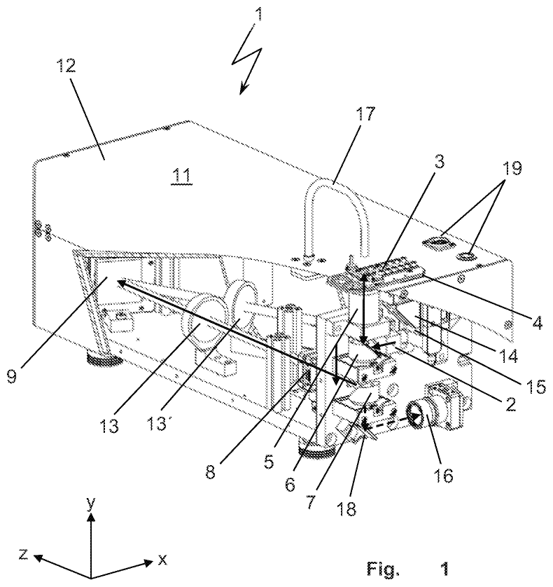

FIG. 1: an isometric illustration of the instrument with a cutout in the instrument housing,

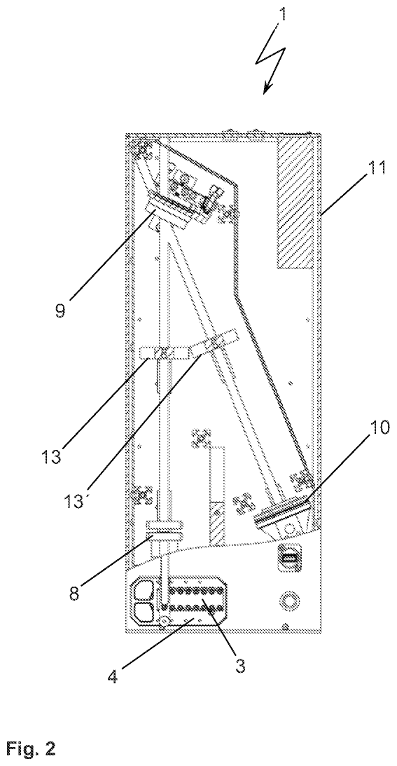

FIG. 2: the instrument with a fluidics module fixed in place thereon in plan view with a cutout on the top side of the housing,

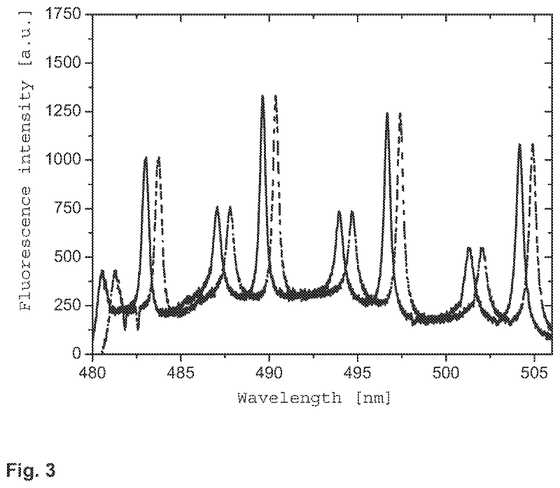

FIG. 3: an example for the influencing of the spectrum detected by the optical receiver occurring during adsorption operation,

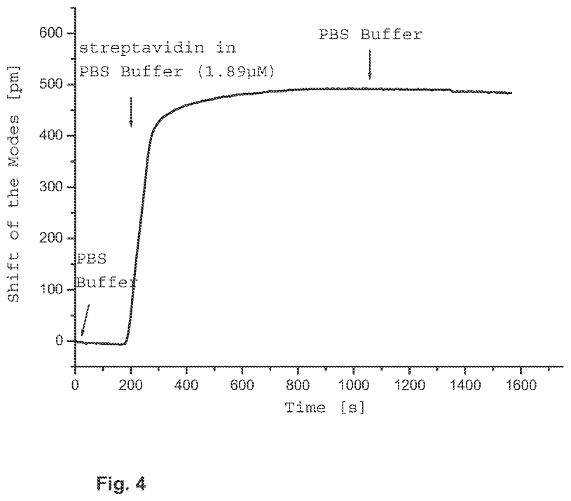

FIG. 4: an example for the time-dependent shift of the mode position during an adsorption operation.

FIG. 1 shows an isometric illustration of an exemplary embodiment for the key component part of the apparatus according to the invention, namely, for the instrument 1, which essentially constitutes and characterizes this apparatus and is designed in accordance with the invention, by way of which key components, in particular the optical elements 5, 6, 7, 8, 9, 13, 13′ of the claimed apparatus are accommodated in a common instrument housing 11. In the illustration, the instrument 1 is shown as viewed at an angle from obliquely in front with a cutout made in the instrument housing 11. On account of the cutout made in the illustration, the key components of the apparatus according to the invention that are combined in the common instrument housing 11 are readily seen in the illustration.

Key components of the apparatus that are accommodated by the instrument housing 11 are accordingly a light source 2 for the emission of the light serving for the spectroscopic analysis, or, to be more exact, for the excitation of the dye contained in the microparticles (also not shown in FIG. 1 because of their tiny size) or in the microsensors of the microstructure 3, respectively, and optical elements 5, 6, 7, 8, 9, 13, 13′ for beam guidance and for the optical influencing of the light emitted from this light source 2 as well as of the light modes emitted by the microsensor in the microstructure 3 irradiated currently by the light source 2. What is involved here are a first optical deflection element 6 (in the following, the first beam splitter 6) and a second optical deflection element 7 (in the following, the second beam splitter 7), an objective lens 5, an optical slit aperture 8, an optical grating 9, and two lenses 13, 13′, which serve for focusing the beam. The optical receiver 10, which is likewise a key optical element, that is, a key optical component, is not visible in this drawing, because it is concealed by an intervening wall. However, the optical receiver 10 can be readily seen in FIG. 2, which is yet to be explained below.

A further key component of the apparatus according to the invention, illustrated in FIG. 1, which, however, in the exemplary embodiment shown, is not accommodated by the instrument housing 11, is the fluidics module 3, 4. As can be seen from the figure, it is arranged outside of the instrument housing 11 on the top side of the instrument 1 in immediate proximity to the upper housing wall 12. The fluidics module 3, 4, which is comprised of a carrier 4 that can move in the three spatial dimensions x, y and z, and the microstructure 3 arranged on it, is joined to the instrument 1 by way of suitable means of connection, which are not illustrated in detail in the drawing and which have complementary means of connection, which are likewise not shown, via at least one opening (not shown) in the upper housing wall 12 and, via these complementary connecting elements, are brought into an operative connection with actuators 14, 15 serving for movement of the carrier 4.

The actuators 14, 15 are linear motors and mechanical elements transmitting their movement onto connecting elements coupled to the fluidics module 3, 4. By means of the actuators 14, 15 (xyz stage), the carrier 4 of the fluidics module 3, 4 and, with it, the microstructure 3 arranged on it can be positioned in a controlled manner by a control unit, which is not shown, with respect to the three spatial dimensions in a highly precise manner with an accuracy in the submicrometer range. For the carrying of fluid, by means of which functionalized microparticles suspended therein and/or the respective analyte to be investigated and to be bound to the microparticles introduced beforehand in the microchannels of the microstructure 3, corresponding ports, which are not shown here, are provided at the fluidics module 3, 4. The respective fluid is delivered by means of a pump to the fluidics module 3, 4 via ports formed on the fluidics module for this purpose and are not shown here and via connecting lines attached to these ports, Also not shown in the drawing are the aforementioned connecting lines, the sealing elements required for their connection to the ports of the fluidics module 3, 4, and the mentioned pump.

The emitting light source 2 used for the spectroscopic investigation is, in accordance with the example shown here, a pulse-width-modulated laser, which emits a laser beam in the violet region of the spectrum, namely, with a wavelength of 405 nm. This laser beam, which is guided initially along the coordinate axis x, is deflected by the first beam splitter 6, which is designed in a wavelength-selective manner, namely, is adjusted in this regard to a wavelength of 405 nm, to a second plane and is guided in this second plane along the coordinate axis y onto the microstructure 3 of the fluidics module 3, 4 or, to be more exact, onto a microparticle held and correspondingly positioned therein. Here, in a prototype of the instrument 1 realized in accordance with the exemplary embodiment shown, the light beam of the laser impinges with the formation of a light spot with a diameter of approximately 10 μm and with a power of approximately 1 mW. When the laser beam impinges, the dye contained in the microparticle in question is excited to glow. In the process, a plurality of resonant light modes of different wavelengths in the region of the fluorescence band of the dye used are formed, such as, for example, with wavelengths in the range between 470 and 520 nm, whereby, depending on the resonance wavelengths, two modes that belong to each other, namely, a TE mode and a TM mode, are formed, which, in regard to their electric field components and their magnetic field components, are polarized orthogonally to each other. Portions of this light finally exit the microparticle and, in this respect, are emitted from it.

A portion of the light having the light modes emitted by a microparticle currently exposed to the light of the light source 2 is captured by a recess in the housing wall 12 by the objective lens 5 and, via the latter, is guided, opposite to the direction of the light of the light source 2 that impinges on the microparticle, likewise along the coordinate axis y in the instrument 1. Here, these modes penetrate, that is, pass, initially the first beam splitter 6, which does not reflect the wavelengths of these modes, and finally impinge on the second beam splitter 7, which is designed to be selective in regard to these wavelengths. By way of the second beam splitter 7, light with wavelengths of less than 550 nm is deflected, in turn, to another plane and guided there along the coordinate axis z, initially via the optical slit aperture 8 serving for beam formation and then onto the optical grating 9. Light with wavelengths of greater than 550 nm, in contrast, also passes the second beam splitter 7 and is guided below the beam splitter 7 through a deflecting mirror 18 to a camera 16 utilized for imaging.

The arrows inscribed in the figure are intended to highlight the above-described light pathways, whereby a corresponding double arrow is intended to make visible the fact that the segment between the first beam splitter 6 and the microstructure 3 is passed by light in a changing direction, namely, on the one hand, by the light of the light source 2 that has been deflected by the first beam splitter 6 along the coordinate axis y in the direction of the microstructure and, on the other hand, by the light modes that are emitted by the respective microparticle of the microstructure 3 exposed to this light and, after entering the instrument housing 11, pass the first beam splitter 6 via the objective lens 5—symbolized by the arrow extension between the first beam splitter 6 and the second beam splitter 7.

The light modes that are guided onto the optical grating 9 and are utilized for the spectroscopic investigation are reflected by the grating and the reflected light is thereby fanned out in terms of its wavelength spectrum and finally guided to the optical receiver 10 (see FIG. 2), which cannot be seen here. A converging lens 13, 13′, which serves for focusing the beam, is arranged between the optical slit aperture 8 and the optical grating 9, on the one hand, as well as between the optical grating 9 and the optical receiver 10, on the other hand. In the case of the pair of converging lenses 13, 13′, two lenses are involved that are identical in regard to their optical properties. The light captured by the optical receiver 10 is analyzed, in turn, by means of a processing unit, which is not shown here. In the process, in regard to modes that belong to each other (TM modes and TE modes, which are polarized orthogonally to each other), at least the modes of maximum light intensity are taken for analysis in each instance.

In addition, in terms of the shift of the respective peak wavelength that occurs for these modes over time on account of the binding of an analyte to the microsensor that emits these modes (analysis of binding kinetics relative to an adsorption rate) or on account of the release of an analyte that is bound to the microsensor already at the start of the analysis operation (analysis of binding kinetics relative to a desorption rate), a plurality of modes of different resonance wavelengths are evaluated. This makes it possible to determine the exact particle size (the particle diameter) of the microsensor being observed and to take this into account in the determination of the adsorption rate or desorption rate, as a result of which, finally, a higher resolution of the measurement result is obtained.

Thus, for example, the adsorption of a polymer layer with a thickness of 2 nm to 3 nm on the sensor surface produces a shift in the mode wavelengths of approximately 200 pm to 300 pm depending on the refractive index of the polymer. In order to be able to detect the adsorption of a few molecules on the surface in an effective manner, therefore, it is necessary to detect shifts of at least 20 pm or better. This necessitates an extremely high-resolution spectroscopic arrangement, which is realized with the apparatus according to the invention. In tests, by use of an apparatus in accordance with the exemplary embodiment explained here, it was possible to achieve resolutions of less than 10 pm.

As already discussed in the general illustration of the invention, the last-mentioned analysis unit and the control unit or the control units for control of the light source 2, for control of the actuators 14, 15 for the positioning of the fluidics module 3, 4, and for control of the means for the movement and carrying of the fluid containing the microparticles and/or of the fluid containing the analyte can be realized jointly by a microcontroller system.

The operations of exposure of a microsensor (microparticle) held in the microstructure 3 to the light of the light source 2 and of guiding the light modes emitted as a result of this exposure of this microsensor onto the optical receiver 10, operations which have become manifest from the preceding discussions, are repeated several times during an analysis process. A corresponding microparticle that is functionalized for the analyte to be investigated is initially irradiated here, in the absence of the analyte, with the light of the pulse-width-modulated laser (light source 2), and an analysis of the light modes that are emitted from the microparticle as a result thereof is carried out. Afterwards, the fluidics module 3, 4, that is, the microstructure 3 thereof, is flushed by the fluid containing the analyte to be investigated. During this process, the measurement at a respectively observed microparticle of the microstructure 3 is repeated, namely, as desired, in accordance with the expected rate of the binding-kinetics processes that are to be detected, at a scanning rate of up to 25 Hz. This means that the microparticle in question is exposed repeatedly to the light of the laser and, in each instance, the light modes incident on the optical receiver 10 are analyzed. During this operation, on account of ongoing binding of the analyte to the microparticle, leading to saturation, the peak wavelength of the light modes emitted by the microparticle shifts. From this shift, as highlighted by way of example in the spectrum shown in FIG. 3, the time course of the binding of the analyte to the microparticle, that is, the adsorption rate of the analyte, is automatically calculated. An exemplary result of this calculation is highlighted by FIG. 4.

The light emitted in each case by a microparticle of the microstructure 3, as already discussed, is captured by means of the objective lens 5. In accordance with the exemplary embodiment, the objective lens 5 is a special objective lens with a 20× magnification and a numerical aperture of at least 0.75.

The special beam guidance of the light within the instrument housing 11 makes possible a very compact construction for the instrument 1, while ensuring that it is possible to determine adsorption rates very precisely by means of the apparatus according to the invention with the instrument 1 as its main component part. In the case of the already mentioned prototype of the instrument 1, given an edge length of the instrument housing 11 of approximately 223 mm in width, approximately 193 mm in height, and approximately 568 mm in depth (length), a beam path length of approximately 400 mm of the light modes guided to the optical receiver 10 is realized for the light emitted by the irradiated microparticle for the determination of the adsorption rate. The instrument or the apparatus, respectively, thereby makes it possible under the constraints already mentioned above (in particular: light source 2=pulse-modulated laser with a wavelength of 405 nm, exposure of a microparticle of the microstructure with a light power of 1 mW for a light spot that is approximately 10 μm in diameter, emission of light modes by the respectively irradiated microparticle held in the microstructure 3 in the range of 470 nm to 520 nm, and use of a 20× magnification objective lens with NA≥0.75) for the determination of the respective peak wavelengths of the light modes incident at the optical receiver, an optical resolution of <10 pm, which, by way of interpolation, namely, by way of a modeling of the curves to a Lorentz distribution, is increased to a resolution of approximately 5 pm.

The already mentioned camera 16, which, in the illustration, is arranged at the bottom right within the instrument housing 11, serves, in combination with a display (not shown here) connected to it, for the optical monitoring of the position of the fluidics module 3, 4 and for a service technician or an operator to monitor the course of the adsorption operation. For support of the imaging in the design in accordance with the exemplary embodiment shown, a diffuse light source (for example, an LED-based light source) is arranged above the fluidics module 3, 4, likewise outside of the instrument housing 11, as an additional lighting means 17.

Besides its compact construction, the instrument 1 is additionally characterized by a high robustness and a low service requirement. On account of the arrangement of the fluidics module 3, 4 outside of the instrument housing 11, its simple exchange is possible without intrusion in the instrument 1, which, at the same time, brings with it a high ease of use. For operation of the instrument 1 in carrying out an analysis operation for the determination of an adsorption rate, there are, in the instrument 1 shown in the example, on its top side, operating and connecting elements 19, namely, an on-off switch and a USB port for data exchange. In regard to the complexity and relatively high sensitivity of the optics arranged in the interior of the instrument 1, there is a further advantage in this context in that only very few adjustment possibilities for adjusting the components and elements of these optics are provided, which limit the calibration adjustments that are unavoidable in the individual case. Thus, for example, there exists in regard to the latter, preferably for a service technician, the possibility of calibrating the actuators 14, 15 for the positioning of the carrier 4 with the microstructure 3 of the fluidics module 3, 4 arranged on it. The service technician is thereby assisted by the graphic reproduction of partial regions of the microstructure by means of the camera 16.

FIG. 2 shows in plan view the instrument 1 illustrated in FIG. 1 and explained previously once again, whereby the housing wall 12 on the instrument top side has been partially cut out for the illustration. In this illustration, besides the optical slit aperture 8, the optical grating 9, and the two identical converging lenses 13, 13′, in particular the spectrometer with the optical receiver 10 can also be seen. In order to avoid residual light influence due to surrounding light, which might impair the accuracy of the measurement results, the spectrometer is accommodated within the instrument housing 11 by yet a further housing. The fluidics module 3, 4 can also likewise be readily seen once again in FIG. 2.

FIG. 3 shows, by way of example, the shift of the peak wavelengths, such as they can be observed for light modes emitted by a microparticle with a diameter of 7 pm during an adsorption operation. The solid line shows the spectrum of the light modes that are emitted by the microparticle prior to the start of adsorption for an exposure to the light of the light source 2 and are detected by the optical receiver 10. The dashed line shows the corresponding spectrum at the end of the adsorption of streptavidin in PBS buffer (PBS=phosphate buffered saline) to the biotinylated particle surface.

FIG. 4 illustrates, by way of example, the time-dependent shift of the mode position or of the peak wavelengths, respectively, of the modes that are emitted by a 10-μm microparticle during the adsorption of a solution of streptavidin in PBS buffer to the biotinylated particle surface and are detected by means of the optical receiver 10.

### LIST OF REFERENCE SYMBOLS

1 instrument

2 light source

3, 4 fluidics module comprising the microstructure 3 and the carrier 4

5 objective lens

6 first optical deflection element (first beam splitter)

7 second optical deflection element (second beam splitter)

8 optical slit aperture

9 optical grating

10 optical receiver

11 instrument housing

12 housing wall

13, 13′ converging lens

14, 15 actuators for movement in the x, y, z direction

16 camera

17 (additional) lighting means

18 deflecting mirror

19 operating and connecting elements

1. An apparatus for the label-free quantitative spectroscopic determination of the binding kinetics of an analyte, comprising
a light source for the emission of light used for the spectroscopic analysis,
a fluidics module, composed of a movable carrier and of a microstructure which is arranged on this carrier and through which a fluid can flow, having at least one spherical microparticle that is held in this microstructure and functions as an optically active microsensor that is designed for the adsorption of an analyte that is carried in a fluid to the microstructure or for the release of an analyte that binds to its surface into a fluid carried to the microstructure, and for the emission of light modes as a result of exposure to the light of the light source,
optical elements for beam guidance and for the optical influencing of the light that is emitted from the light source as well as light modes that are emitted by the microsensor held in the microstructure and impinge on an objective lens of the optical elements,
an optical receiver for the reception of light modes that are emitted by a microsensor held in the microstructure and guided via the objective lens,
actuators for the positioning of the carrier of the fluidics module,
means for the movement and carrying of a fluid to the fluidics module,
an analysis unit that, together with the optical receiver, forms a spectrometer for the determination of the binding kinetics of the particular analyte observed in this respect by analysis of the light modes received through the optical receiver,
at least one control unit for control of the light source, for control of actuators for the positioning of the carrier with the microstructure, and for control of the means for the movement and carrying of fluid, wherein the analysis unit and the at least one control unit can constitute a common unit, is hereby characterized in that at least the light source, the optical elements, the optical receiver, and the actuators for the positioning of the carrier are arranged together in an instrument with an instrument housing, and in that the light is guided within the instrument housing by means of the optical elements in three different planes by deflecting the light that is emitted by the light source and initially guided in a first plane by means of a first optical deflection element to a second plane for the exposure of a microsensor held by the microstructure, and by deflecting the light modes, which are guided initially in the opposite direction likewise in this second plane and are emitted by the microsensor held in the microstructure as a result of light exposure and which are taken for the determination of the binding kinetics of the analyte, by means of a second optical deflection element to a third plane that is different from the first plane and the second plane and by guiding these light modes via further optical elements to the optical receiver.

2. The apparatus according to claim 1, further characterized in that the fluidics module is arranged outside of the instrument housing at a housing wall of the instrument, wherein, via a connecting means provided for this purpose by way of at least one cutout in the housing wall, the carrier is brought into an operative connection with complementary connecting means, which can be moved by means of the actuators serving for the positioning of the carrier with the microstructure arranged on it.

3. The apparatus according to claim 1, further characterized in that the light emitted by the light source is guided initially within the instrument housing along a first coordinate axis of the chamber and is then deflected by means of a first beam splitter forming the first optical deflection element in a wavelength-selective manner and is guided along a second coordinate axis, which is orthogonal to the first coordinate axis, within the space of the microstructure, and in that the light modes emitted by a microsensor held in the microstructure as a result of the light exposure are guided initially along the aforementioned second coordinate axis in the opposite direction to the light guided onto the microstructure for light exposure of the microsensor and then deflected by means of a second beam splitter that forms the second optical deflection element in a wavelength-selective manner, and guided along a third coordinate axis in the space, which is orthogonal to both to the first and second coordinate axis, via an optical slit aperture to an optical grating, and finally the light that is reflected by the grating and fanned out according to wavelength is guided to the optical receiver.

4. The apparatus according to claim 3, further characterized in that, arranged also in the common instrument, is a camera, which can be connected to an imaging system via signal connection terminals placed on the instrument housing, and light components passing the second beam splitter without deflection are guided to this camera.

5. The apparatus according to claim 4, further characterized in that a lighting means is arranged on the instrument housing, for an additional illumination of the fluidics module for the purpose of its graphic detection by means of the camera.

6. The apparatus according to claim 5, further characterized in that at least one diffuse light source is involved in the additional lighting means.

7. The apparatus according to claim 1, further characterized in that the objective lens that captures the light modes emitted by the microsensor held in the microstructure involves a long-distance dry objective lens.

8. The apparatus according to claim 7, further characterized in that the objective lens is an objective lens with a 10× to 40× magnification, preferably with a 20× magnification, and with a numerical aperture NA of between 0.6 and 1.2, preferably ≥0.75.

9. The apparatus according to claim 1, further characterized in that the light source for the emission of the light used for the spectroscopic analysis is a pulse-width-modulated laser with a power of between 0.1 mW and 10 mW, preferably of between 0.5 mW and 1.5 mW.

10. The apparatus according to claim 9, further characterized in that the laser that constitutes the light source emits light with a wavelength in the range of between 350 nm and 600 nm, preferably of between 400 nm and 500 nm.

11. The apparatus according to claim 9, further characterized in that the light exposure of a microsensor held by the microstructure takes place with the light of the light source only for the duration of a measurement operation relating to the microsensor in question.

12. The apparatus according to claim 1, further characterized in that the optical receiver for reception of the light modes taken for the determination of the binding kinetics of the analyte involves a CCD or CMOS line scan camera.

13. The apparatus according to claim 1, further characterized in that the optical receiver is surrounded by a double-wall housing, and in that it is accommodated separately within the instrument housing by a further housing.

14. The apparatus according to claim 1, further characterized in that, in the instrument housing, is also arranged the analysis unit for the determination of the binding kinetics of the analyte and/or the at least one control unit for control of the light source, for control of the actuators for the positioning of the carrier with the microstructure, and for control of the means for the movement and carrying of fluid.
